(19) United States
(12) Patent Application Publication
(10) Pub. No.: US 2024/0262995 A1
(43) Pub. Date: Aug. 8, 2024

(54) COMPOSITIONS AND METHODS RELATING TO IMPACT COPOLYMER COMPATIBILIZERS

(71) Applicant: EXXONMOBIL TECHNOLOGY AND ENGINEERING COMPANY, Spring, TX (US)

(72) Inventors: George J. PEHLERT, Houston, TX (US); Ranadip GANGULY, Houston, TX (US)

(73) Assignee: EXXONMOBIL TECHNOLOGY AND ENGINEERING COMPANY, Spring, TX (US)

(21) Appl. No.: 18/425,773

(22) Filed: Jan. 29, 2024

Related U.S. Application Data
(60) Provisional application No. 63/482,929, filed on Feb. 2, 2023.

(51) Int. Cl. C08L 23/12; B29B 9/12; B29C 45/00; B29C 48/00; B29K 69/00; C08J 3/12; C08J 3/20

(52) U.S. Cl. CPC C08L 23/12; B29B 9/12; B29C 45/0001; B29C 48/022; C08J 3/12; C08J 3/203; B29K 2069/00; B29K 2995/0082; C08J 2323/12; C08L 2205/03; C08L 2207/04

(57) ABSTRACT

Relates to a thermoplastic polyolefin composition including from 50 wt % to 90 wt % of a polypropylene having a melt flow rate from 10 g/10 min to 200 g/10 min; from 10 wt % to 45 wt % of an ethylene-α-olefin copolymer having a melt flow rate from 0.1 g/10 min to 10 g/10 min; from 0.1 wt % to 5 wt % of a propylene-based elastomer having a melt flow rate from 0.1 g/10 min to 10 g/10 min; wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

### FIELD

The present disclosure relates to compatibilizers for impact copolymer compositions and related methods.

### BACKGROUND

Impact copolymer (ICP) (sometimes referred to as “block copolymer”) compositions are polymer blends that include a polypropylene matrix and a dispersed ethylene-α-olefin phase.

Typically, ICPs are multiphase polymer blends where a polypropylene forms a continuous matrix phase and the elastomer component, generally derived from an ethylene containing interpolymer, is the dispersed component. The polypropylene matrix imparts tensile strength and chemical resistance to the ICP, while the ethylene polymer imparts toughness and impact resistance. Typically, ICPs have a dispersed phase which is not, or only modestly, cross-linked.

Traditionally, very low density ethylene-propylene (EP) copolymers and ethylene-propylene-diene (EPD) terpolymers have been used as the modifier component in ICP compositions, these EP copolymers or EPD terpolymers generally have a high molecular weight expressed in Mooney units. Subsequently, it has been observed that certain non-crosslinked ICP compositions have improved processability, and also improved mechanical properties, when the compositions contain high levels of isotactic polypropylene, for example, above 70 wt %. Generally, one of the problems with adding more isotactic polypropylene to any thermoplastic composition is a noticeable drop in ductility. For example, any improvement in a mechanical or impact property, such as Notched Izod impact, tends to be accompanied by an undesirably high loss of stiffness, such as flexural modulus. Such a trade-off is of great concern for the makers of automotive parts, one of the major markets for ICPs, particularly in the application of bumper fascia. Other applications include automotive interior components such as door skin, air bag cover, side pillars and the like. These parts are generally made using an injection molding process. To increase efficiency and reduce costs it is necessary to decrease molding times and reduce wall thickness in the molds. To accomplish these goals, manufacturers have turned to high melt flow polypropylenes (melt flow rate greater than 35 g/10 min). These high melt flow rate (MFR) resins, however, are low in molecular weight and consequently difficult to toughen, resulting in products that have low impact strength.

### SUMMARY

The present disclosure relates to compatibilizers for ICP compositions and related methods.

A nonlimiting composition of the present disclosure includes a thermoplastic polyolefin composition comprising: from 50 wt % to 90 wt %, by weight of the composition, of a polypropylene comprising from 90 wt % to 100 wt % propylene derived units and having a melt flow rate from 10 g/10 min to 200 g/10 min; from 10 wt % to 45 wt %, by weight of the composition, of an ethylene-α-olefin copolymer comprising from 30 wt % to 65 wt % ethylene-derived units and having a melt flow rate from 0.1 g/10 min to 10 g/10 min; from 0.1 wt % to 5 wt %, by weight of the composition, of a propylene-based elastomer having from 10 wt % to 60 wt % alpha-olefin derived units, having a melt flow rate from 0.1 g/10 min to 10 g/10 min; wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

A nonlimiting method of the present disclosure for producing a thermoplastic polyolefin composition includes (a) providing a polypropylene having a melt flow rate from 10 g/10 min to 200 g/10 min; (b) providing an ethylene-α-olefin copolymer comprising from 30 wt % to 65 wt % ethylene-derived units and having a melt flow rate from 0.1 g/10 min to 10 g/10 min; (c) providing a propylene-based elastomer having from 10 wt % to 60 wt % alpha-olefin derived units, having a melt flow rate from 0.1 g/10 min to 10 g/10 min; (d) forming a composition by combining, in any order, the polypropylene, the ethylene-polypropylene copolymer, and the propylene-based elastomer; (c) wherein the propylene comprises 50 wt % to 90 wt %, by weight of the composition; (f) wherein the ethylene-polypropylene copolymer comprises 10 wt % to 45 wt %, by weight of the composition; (g) wherein the propylene-based elastomer comprises 0.1 wt % to 5 wt %, by weight of the composition; and (h) wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

These and other features and attributes of the disclosed systems and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a graph of flexural modulus testing results of exemplary compositions of the present disclosure.

FIG. 2 illustrates a graph of particle size distribution data of exemplary compositions of the present disclosure.

FIG. 3A illustrates a microscopy image of a matrix-particle interface for an exemplary control of the present disclosure.

FIG. 3B illustrates a microscopy image of a matrix-particle interface for an exemplary sample of the present disclosure.

### DETAILED DESCRIPTION

The present disclosure relates to compatibilizers for ICP compositions and related methods. Advantageously, the compatibilizers described herein may improve the impact resistance properties and/or toughness properties of the ICP composition while maintaining a suitable level of stiffness. These improved properties without significant stiffness loss may be highly desired in automotive and other specialty applications.

The compatibilizers described herein may reduce interfacial tension and improve compatibility between a matrix phase and a dispersed phase within ICP compositions. Without being bound by theory, this improved compatibility may result from the compatibilizer properties, which may be between those of the matrix and dispersed phases, allowing for the compatibilizer to interface with both phases. Additionally, the compatibilizers may also help control the particle (dispersed phase) morphology in ICP compositions, allowing for greater control of particle-matrix interactions, leading to the advantageous properties described above.

Disclosed herein are ICP compositions comprising a polypropylene, an ethylene-α-olefin copolymer, and a propylene-based elastomer. More particularly, the ICP compositions of the present disclosure may comprise: (i) a polypropylene comprising from 60 wt % to 100 wt % propylene derived units and having a melt flow rate from 10 g/10 min to 200 g/10 min, (ii) an ethylene-α-olefin copolymer comprising from 30 wt % to 65 wt % ethylene-derived units and having a melt flow rate from 0.1 g/10 min to 10 g/10 min, and (iii) a propylene-based elastomer having from 10 wt % to 60 wt % alpha-olefin derived units and having a melt flow rate from 0.1 g/10 min to 10 g/10 min.

The melt flow rate of the propylene-based elastomer may be between the melt flow rate of the polypropylene and the melt flow rate of the ethylene-α-olefin copolymer. The melt flow rate of the propylene-based elastomer may be in a middle 75% range, middle 60% range, middle 50% range, or middle 40% range, or middle 25% range between the melt flow rate of the polypropylene and the melt flow rate of the ethylene-α-olefin copolymer. By way of nonlimiting example, the melt flow rate of the polypropylene may be 15 g/10 min, and the melt flow rate of the ethylene-α-olefin copolymer may be 1 g/10 min. Accordingly, a melt flow rate of 2.75 g/10 min to 13.25 g/10 min for the propylene-based elastomer is within the middle 75% range of between the melt flow rate of the polypropylene and the melt flow rate of the ethylene-α-olefin copolymer.

Melt flow rate (MFR) as described in the present disclosure is measured according to ASTM D1238-20 with conditions of 230° C. and 2.16 kg unless otherwise noted. High load MFR is measured according to ASTM D1238-20 with conditions of 230° C. and 21.6 kg.

The amount of ethylene-derived units of the propylene-based elastomer may be between the amount of ethylene-derived units of the polypropylene and the amount of ethylene-derived units of the ethylene-α-olefin copolymer. The amount of ethylene-derived units in the propylene-based elastomer may be in a middle 25% range, middle 40% range, middle 50% range, middle 60% range, or middle 75% range between the amount of the ethylene-derived units in the polypropylene and the amount of the ethylene-derived units in the ethylene-α-olefin copolymer.

The polypropylene may be present within a range of from 50 wt % to 90 wt % (or 60 wt % to 80 wt %, or 70 wt % to 80 wt %, or 70 wt % to 90 wt %, or 50 wt % to 80 wt %). The ethylene-α-olefin copolymer may be present within a range from 10 wt % to 45 wt % (or 10 wt % to 30 wt %, or 10 wt % to 20 wt %, or 20 wt % to 40 wt %, or 15 wt % to 35 wt %). The propylene-based elastomer may be present to within a range from 0.1 wt % to 5 wt % (or 0.1 wt % to 4 wt %, or 0.1 wt % to 2.5 wt %, or 1 wt % to 5 wt %, or 1 wt % to 4 wt %, or 1 wt % to 3 wt %). The above described wt % ranges are each based on the weight of all ingredients of the ICP composition. The remainder of the ICP composition comprising any common additives as is known in the art. There may be only a physical change in the formation of a “continuous” phase primarily of polypropylene and a “discontinuous” phase or “discrete” phase comprising mostly the ethylene-α-olefin copolymer; however, there may be some chemical “reaction” between the primary components of the ICP compositions described in the present disclosure. These three primary components of the ICP composition are described in more detail herein.

### Polypropylene

The polypropylene of the ICP compositions form the continuous phase (or matrix) of the ICP compositions described herein.

Polypropylenes of the ICP compositions described herein may be a homopolymer or copolymer comprising 90 wt % or greater (or 90 wt % to 100 wt %, or 90 wt % to 99 wt %, or 60 wt % to 100 wt %, or 60 wt % to 99 wt %, or 60 wt % to 98 wt %, or 70 wt % to 95 wt %, or 60 wt % to 90 wt %, or 60 wt % to 80 wt %, or 70 wt % to 90 wt %) propylene-derived units. Polypropylenes of the ICP compositions described herein may comprise less than 40 wt % (or 0 wt % to 40 wt %, or 1 wt % to 40 wt %, or 5 wt % to 30 wt %, or 10 wt % to 30 wt %, or 10 wt % to 20 wt %, or 1 wt % to 20 wt %, or 1 wt % to 30 wt %) C₂ and/or C₄ to C₁₀ α-olefin derived units. Said polypropylenes may be made by any desirable process using any desirable catalyst as is known in the art, such as a Ziegler-Natta catalyst, a metallocene catalyst, or other single-site catalyst, using solution, slurry, high pressure, or gas phase processes. Certain polypropylenes that find use in the ICP compositions described herein may be within the range from 0.2 wt % to 5 wt % (or 0.2 wt % to 2 wt %, or 0.2 wt % to 1 wt %, or 0.5 wt % to 5 wt %, or 0.5 wt % to 2 wt %, or 0.5 wt % to 1 wt %) ethylene-derived units.

Polypropylene copolymers, especially copolymers of propylene with ethylene and/or butene, may be useful at the polypropylene of the ICP composition and comprise propylene-derived units within the range of from 70 wt % to 98 wt % (or 70 wt % to 95 wt %, or 70 wt % to 90 wt %, or 80 wt % to 98 wt %, or 70 wt % to 80 wt %) by weight of the polypropylene.

The term “crystalline,” as used herein, characterizes those polymers which possess high degrees of inter- and intra-molecular order. Preferably, the polypropylene has a heat of fusion (Hf) greater than 60 J/g or greater than 70 J/g or greater than 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer. A “highly crystalline” polypropylene is preferred in certain embodiments of the present disclosure, and is typically isotactic and comprises 100 wt % propylene-derived units (propylene homopolymer).

The polypropylenes useful in the present disclosure may have a glass transition temperature (ISO 11357-1, T_{g}) preferably less than −20° C. (or −60° C. to −20° C., or −50° C. to −20° C., or −50° C. to −30° C.). Preferably, the polypropylenes may have a Vicat softening temperature (ISO 306, or ASTM D1525-17) of greater than 120° C., or greater than 110° C., or greater than 105° C., or greater than 100° C., or within a range of from 100° C. to 150° C., or 105° C. to 140° C., or 110° C. to 150° C., or 110° C. to 140° C., or 100° C. to 120° C.

Preferably, the polypropylene may have an MFR (ASTM D1238-20, 230° C., 2.16 kg) within the range from 5 g/10 min to 200 g/10 min (or 10 g/10 min to 200 g/10 min, or 15 g/10 min to 200 g/10 min, or 18 g/10 min to 200 g/10 min, or 20 g/10 min to 200 g/10 min, or 30 g/10 min to 200 g/10 min, or 60 g/10 min to 200 g/10 min, or 100 g/10 min to 200 g/10 min, or 50 g/10 min to 150 g/10 min, or 5 g/10 min to 100 g/10 min).

Suitable grades of polypropylene that are useful in the compositions described herein include those made by ExxonMobil, LyondellBasell, Total, Borealis, Japan Polypropylene, Mitsui, and other sources. A description of semi-crystalline polypropylene polymers and reactor copolymers can be found in “Polypropylene Handbook,” (E. P. Moore Editor, Carl Hanser Verlag, 1996).

### Ethylene-α-Olefin Copolymer

The ethylene-α-olefin copolymers of the ICP compositions form the disperse phase of the ICP compositions described herein.

The sizes of the individual domains of the dispersed phase are preferably small. As measured by atomic force microscopy (AFM), the ICP compositions described in the present disclosure may have an average particle size for the disperse phase of less than 10 μm (or 0.01 μm to 10 μm, or 0.05 μm to 10 μm, or 0.05 μm to 7 μm, or 0.1 μm to 10 μm, or 0.1 μm to 7 μm, or 0.1 μm to 5 μm, or 0.1 μm to 5 μm, or 2 μm to 10 μm, or 2 μm to 7 μm), wherein the particle size is the smallest length dimension of any particle. Particle size is the largest diameter of the particle of the disperse phase. The average particle size is based on a number of particles for which the particle size was measured (preferably at least 100 measurements) rather than weight or volume.

As measured by atomic force microscopy (AFM), the ICP compositions described in the present disclosure may also have an average interparticle spacing of less than 10 μm (or 0.01 μm to 10 μm, or 0.05 μm to 10 μm, or 0.05 μm to 7 μm, or 0.1 μm to 10 μm, or 0.1 μm to 7 μm, or 0.1 μm to 5 μm, or 0.1 μm to 5 μm, or 2 μm to 10 μm, or 2 μm to 7 μm). The interparticle spacing is the smallest length dimension between any two particles. Again, the average is based on a number with at least 100 measurements being preferable.

The ethylene-α-olefin may have density of less than 0.900 g/cm³, or less than 0.895 g/cm³, or less than 0.890 g/cm³, or less than 0.885 g/cm³, or less than 0.865 g/cm³, or less than 0.860 g/cm³.

The ethylene-α-olefin copolymer may be substantially free of propylene crystallinity, or having <10% or <5% or <1% or 0% (or 0% to 10%) of propylene crystallinity of the modifier component as determined by Differential Scanning calorimetry (DSC).

The ethylene-α-olefin copolymers comprise ethylene-derived units, α-olefin derived units (e.g., C3 to C20 derived units), and optionally diene derived units. Examples of α-olefins may include, but are not limited to, propylene, 1-butene, 1-pentene, 1-hexene, 1-heptene, 1-octene, 1-nonene, 1-decene, 2-methyl-1-propene, 3-methyl-1-pentene, 4-methyl-1-pentene, 5-methyl-1-hexene, and mixtures thereof. Copolymers of ethylene and propylene and ethylene and/or propylene with another α-olefin such as 1-butene, 1-hexene, 1-octene, 2-methyl-1-propene, 3-methyl-1-pentene, 4-methyl-1-pentene, 5-methyl-1-hexene, the like, or mixtures thereof. Examples of dienes may include, but are not limited to, 5-ethylidene-2-norbornene, 5-vinyl-2-norbornene, divinyl benzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, or a combination thereof.

The ethylene-α-olefin copolymer may comprise the ethylene-derived units in an amount of 40 wt % to 80 wt % (or 45 wt % to 65 wt %, or 45 wt % to 60 wt %, or 60 wt % to 80 wt %, or 40 wt % to 65 wt %).

The ethylene-α-olefin copolymer may comprise the α-olefin derived units in an amount of greater than 30 wt % based on the copolymer, or greater than 40 wt %, or greater than 50 wt % (or 30 wt % to 99 wt %, or 30 wt % to 100 wt %, or 50 wt % to 99 wt %, or 50 wt % to 100 wt %). If the optional diene is present, it may range from 0.5 wt % to 10 wt %, or from 0.5 wt % to 7 wt %.

The ethylene-α-olefin copolymer may have an MFR (ASTM D1238-20, 230° C., 2.16 kg) within the range from 0.1 g/10 min to 20 g/10 min (or 2 g/10 min to 20 g/10 min, or 4 g/10 min to 15 g/10 min, or 10 g/10 min to 20 g/10 min, or 12 g/10 min to 20 g/10 min, or 1 g/10 min to 10 g/10 min, or 2 g/10 min to 12 g/10 min). The EP copolymer also preferably may have a high-load MFR (ASTM D1238-20, 230° C., 21.6 kg) within the range of from 100 g/10 min to 280 g/10 min (or 100 g/10 min to 200 g/10 min, or 200 g/10 min to 280 g/10 min).

The ethylene-α-olefin copolymer may have a number average molecular weight (Mn), as determined by GPC, of from 30,000 g/mol to 500,000 g/mol (or 30,000 g/mol to 250,000 g/mol, or 30,000 g/mol to 100,000 g/mol, or 50,000 g/mol to 100,000 g/mol, or 50,000 g/mol to 250,000 g/mol, or 100,000 g/mol to 500,000 g/mol). The copolymer may have a weight average molecular weight (Mw) within a range of from 50,000 g/mol to 300,000 g/mol (or 60,000 g/mol to 300,000 g/mol, or 50,000 g/mol to 200,000 g/mol, or 60,000 g/mol to 200,000 g/mol, or 60,000 g/mol to 120,000 g/mol). The copolymer may have an Mw/Mn within the range from 1.8 to 4.0 (or 1.8 to 2.8, or 2.0 to 4.0, or 2.0 to 3.0).

Also, the ethylene-α-olefin copolymer preferably may have a glass transition temperature (T_{g}) within a range of from −130° C. to −10° C. (or −100° C. to −10° C., or −80° C. to −10° C., or −100° C. to −20° C., or −80° C. to −20° C., or −40° C. to −10° C.).

The ethylene-α-olefin copolymer may or may not contain long chain branches, whose presence may be inferred from rheology type measurements such as melt tension and the internal energy of activation for melt flow. The ethylene-α-olefin copolymer may comprise polymers derived from cyclic mono-olefins such as styrene and both linear and cyclic dienes can also be used. For a discussion of such dienes, U.S. Pat. No. 6,245,856 is incorporated by reference. The ethylene-α-olefin copolymer may be linear, substantially linear, blocky or branched. For a discussion of such options, U.S. Pat. No. 6,245,856 is incorporated by reference.

The ethylene-α-olefin copolymer may be produced using a metallocene based catalyst or other single site catalysts systems in gas phase or solution processes. The metallocene based catalysts used for such polymerizations may generally be of the metallocene-alumoxane, metallocene-ionizing activator type. Useful catalysts may be those disclosed in EP0129368 and U.S. Pat. Nos. 5,026,798 and 5,198,401, each incorporated herein by reference. Most preferably, the ethylene-α-olefin copolymer may be formed by a polymerization reaction between ethylene, an amount of comonomer selected from one or more of propylene, butylene, hexene, and octene, and a bridged hafnocene or zirconocene, most preferably a bridged, unbalanced hafnocene or zirconocene. By “unbalanced” what is meant is that the two primary cyclopentadienyl ligands, or ligand isolobal to cyclopentadienyl, are not the same, such as a cyclopentadienyl-fluorenyl hafnocene or zirconocene, or an indenyl-fluorenyl hafnocene or zirconocene.

### Propylene-Based Elastomer

The propylene-based elastomer of the ICP compositions may act as a compatibilizer and reside, primarily, at the interface between the polypropylene continuous phase and the ethylene-α-olefin copolymer disperse phase.

The propylene-based elastomer may comprise propylene-derived units and a comonomer-derived unit. Examples of comonomers include, but are not limited to, ethylene and/or C₄-C₁₂ α-olefins. The C₄-C₁₂ α-olefin comonomer units may be derived from butene, pentene, hexene, 4-methyl-1-pentene, octene, decene, the like, or any combination thereof. In preferred embodiments, the comonomer is ethylene. In some embodiments, the propylene-based polymer composition consists essentially of propylene and ethylene, or consists of propylene and ethylene.

The propylene-based elastomer may comprise 5 wt % to 30 wt % (or 20 wt % to 25 wt %, or 15 wt % to 20 wt %, or 5 wt % to 15 wt %, or 10 wt % to 30 wt %, or 10 wt % to 25 wt %) comonomer-derived units, where the percentage by weight is based upon the total weight of the propylene-derived and comonomer-derived units.

Optionally, the propylene-based polymer may also include one or more dienes. In embodiments where the propylene-based polymer compositions comprises a diene, the diene may be present at from 0.05 wt % to 6 wt % (or 0.1 wt % to 5.0 wt %, or 0.25 wt % to 3.0 wt %, or 0.5 wt % to 1.5 wt %) diene-derived units, where the percentage by weight is based upon the total weight of the propylene-derived, comonomer-derived, and diene-derived units.

The propylene-based elastomer may comprise 70 wt % to 95 wt % (or 75 wt % to 80 wt %, or 80 wt % to 85 wt %, or 85 wt % to 95 wt %, or 70 wt % to 90 wt %, or 75 wt % to 90 wt %) propylene-derived units, where the percentage by weight is based upon the total weight of the propylene-derived and comonomer-derived units.

The propylene-based elastomer can have a triad tacticity of three propylene units (mmm tacticity), as measured by 13C NMR, of 75% or greater, 80% or greater, 85% or greater, 90% or greater, 92% or greater, 95% or greater, or 97% or greater. The triad tacticity may range from 75 to 99%, or from 80 to 99%, or from 85 to 99%, or from 90 to 99%, or from 90 to 97%, or from 80 to 97%. Triad tacticity is determined by the methods described in U.S. Pat. No. 7,232,871. The propylene-based elastomer may have a tacticity index m/r ranging from a lower limit of 4 or 6 to an upper limit of 8 or 10 or 12.

The propylene-based elastomer may have a % crystallinity of from 0.5% to 40%, or from 1% to 30%, or from 5% to 25%, determined according to DSC procedures.

The propylene-based elastomer may have a density at 22° C. of from 0.85 g/cm³ to 0.92 g/cm³, or from 0.86 g/cm³ to 0.90 g/cm³, or from 0.86 g/cm³ to 0.89 g/cm³, as measured per the ASTM D792-20 test method.

The propylene-based elastomer may have an MFR (ASTM D1238-20, 230° C., 2.16 kg) from 0.1 g/10 min to 1000 g/10 min (or 0.5 g/10 min to 500 g/10 min, or 0.1 g/10 min to 100 g/10 min, or 1 g/10 min to 1000 g/10 min, or 1 g/10 min to 500 g/10 min, or 10 g/10 min to 1000 g/10 min, or 10 g/10 min to 250 g/10 min).

The propylene-based elastomer may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as:

$${g}^{′} = \frac{{η}_{b}}{η ι}$$

where ηb is the intrinsic viscosity of the polymer and ηl is the intrinsic viscosity of a linear polymer of the same viscosity-averaged molecular weight (Mv) as the polymer. ηl=KMvα, K and a are measured values for linear polymers and should be obtained on the same instrument as the one used for the g′ index measurement.

The propylene-based elastomer may have a weight average molecular weight (Mw) of from 50,000 g/mol to 5,000,000 g/mol (or 75,000 g/mol to 1,000,000 g/mol, or 100,000 g/mol to 500,000 g/mol, or 125,000 g/mol to 300,000 g/mol). Most preferably, the weight average molecular weight (Mw) of the propylene-based elastomer may be at least 150,000 g/mol.

The propylene-based elastomer may have a number average molecular weight (Mn) of from 2,500 g/mol to 2,500,000 g/mol (or 5,000 g/mol to 500,000 g/mol, or 10,000 g/mol to 250,000 g/mol, or 25,000 g/mol to 200,000 g/mol). The propylene-based elastomer may have a Z-average molecular weight (Mz) of from 10,000 g/mol to 7,000,000 g/mol (or 50,000 g/mol to 1,000,000 g/mol, or 80,000 g/mol to 700,000 g/mol, or 100,000 g/mol to 500,000 g/mol). The molecular weight distribution (MWD, equal to Mw/Mn) of the propylene-based elastomer may be from 1 to 40 (or from 1 to 15, or from 1.8 to 5, or from 1.8 to 3).

Suitable propylene-based elastomers for use in embodiments of the present disclosure may include VISTAMAXX™ grades available from ExxonMobil Chemical, including VISTAMAXX™ 7050 and VISTAMAXX™ 6202.

Polymerization of the propylene-based elastomer may be conducted by reacting monomers in the presence of a catalyst system described herein at a temperature of from 0° C. to 200° C. for a time of from 1 second to 10 hours. Preferably, homogeneous conditions may be used, such as a continuous solution process or a bulk polymerization process with excess monomer used as diluent. The continuous process may use some form of agitation to reduce concentration differences in the reactor and maintain steady state polymerization conditions. The heat of the polymerization reaction may preferably be removed by cooling of the polymerization feed and allowing the polymerization to heat up to the polymerization, although internal cooling systems may be used.

Further description of exemplary methods suitable for preparation of the propylene-based elastomers described herein may be found in U.S. Pat. Nos. 6,881,800, 7,803,876, 8,013,069, and 8,026,323.

The triad tacticity and tacticity index of the propylene-based elastomer may be controlled by the catalyst, which influences the stereoregularity of propylene placement, the polymerization temperature, according to which stereoregularity can be reduced by increasing the temperature, and by the type and amount of a comonomer, which tends to reduce the level of longer propylene derived sequences.

Too much comonomer may reduce the crystallinity provided by the crystallization of stereoregular propylene derived sequences to the point where the material lacks strength; too little and the material may be too crystalline. The comonomer content and sequence distribution of the polymers can be measured using ¹³C nuclear magnetic resonance (NMR) by methods well known to those skilled in the art. Comonomer content of discrete molecular weight ranges can be measured using methods well known to those skilled in the art, including Fourier Transform Infrared Spectroscopy (FTIR) in conjunction with samples by GPC, as described in Wheeler and Willis, 47 APPLIED SPECTROSCOPY 1128-1130 (1993). For a propylene ethylene copolymer containing greater than 75 wt % propylene, the comonomer content (ethylene content) of such a polymer can be measured as follows: A thin homogeneous film is pressed at a temperature of 150° C. or greater, and mounted on a Perkin Elmer PE 1760 infrared spectrophotometer. A full spectrum of the sample from 600 cm⁻¹ to 4000 cm is recorded and the monomer wt % of ethylene can be calculated according to the following equation: Ethylene wt %=82.585−111.987X+30.045X², where X is the ratio of the peak height at 1155 cm⁻¹ and peak height at either 722 cm⁻¹ or 732 cm⁻¹, whichever is higher. For propylene ethylene copolymers having 75 wt % or less propylene content, the comonomer (ethylene) content can be measured using the procedure described in Wheeler and Willis. Reference is made to U.S. Pat. No. 6,525,157, whose test methods are also fully applicable for the various measurements referred to in this specification and claims and which contains more details on GPC measurements, the determination of ethylene content by NMR and the DSC measurements.

The catalyst systems used for producing the propylene-based elastomer may comprise a metallocene compound. In any embodiment, the metallocene compound may be a bridged bisindenyl metallocene having the general formula (In¹)Y(In²)MX₂, where In¹ and In² are identical substituted or unsubstituted indenyl groups bound to M and bridged by Y, Y is a bridging group in which the number of atoms in the direct chain connecting In¹ with In² is from 1 to 8 and the direct chain comprises C, Si, or Ge; M is a Group 3, 4, 5, or 6 transition metal; and X² are leaving groups. In¹ and In² may be substituted or unsubstituted. If In¹ and In² are substituted by one or more substituents, the substituents are selected from the group consisting of a halogen atom, C₁ to C₁₀ alkyl, C₅ to C₁₅ aryl, C₆ to C₂₅ alkylaryl, and Si-, N- or P-containing alkyl or aryl. Each leaving group X may be an alkyl, preferably methyl, or a halide ion, preferably chloride or fluoride. Exemplary metallocene compounds of this type include, but are not limited to, μ-dimethylsilylbis(indenyl) hafnium dimethyl and μ-dimethylsilylbis(indenyl) zirconium dimethyl.

### Impact Copolymer Compositions

Impact copolymer (ICP) compositions of the present disclosure may be produced by a variety of methods. For example, the propylene-based elastomers may be compounded with previously manufactured compositions (blends) comprising both the polypropylene and the ethylene-α-olefin copolymer. The compounding may occur during a resin manufacturing pelletization step, wherein the resin undergoing pelletization may comprise the polypropylene and the ethylene-α-olefin copolymer. Alternatively, the compounding may occur after all polymer manufacturing steps have occurred, wherein the propylene-based elastomer may be added compounded to a pellet comprising the blend of polypropylene and the ethylene-α-olefin copolymer. Alternatively, the compounding may occur as part of a series reaction wherein the series reactor may be configured to produce a blend that comprises the polypropylene and the ethylene-polypropylene copolymer. Then, a previously-manufactured quantity of the propylene-based elastomer may be added to the series reactor.

Previously manufactured compositions (blends) suitable for compounding with the propylene-based elastomer may include, but are not limited to, PP8255E1 and PP8285E1 (both available from ExxonMobil) and other suitable compositions.

Additives may by present in the ICP compositions described herein and preferably may be present, if at all, to an extent that does not negatively influence the impact or modulus of the ICP composition or components made from the composition. By “consisting essentially of”, what is meant is that the ICP composition may include one or more additives as is known in the art as long as the claimed properties are not altered such that they fall outside the scope of those claimed properties; and by “consisting of” what is meant is that the ICP compositions include additives to a level no greater than 1 wt % or 2 wt % or 3 wt % of the total weight of the ICP composition, or alternatively, additives are not measurably present. The “additives” may include fillers (especially, silica, glass fibers, talc, etc.) colorants, whitening agents, cavitation agents, antioxidants, anti-slip agents, antifogging agents, nucleating agents, stabilizers, and mold release agents. Primary and secondary antioxidants may include, for example, hindered phenols, hindered amines, and phosphates. Nucleating agents may include, for example, sodium benzoate and talc. Dispersing agents such as ACROWAX C may also be included. Slip agents may include, for example, oleamide and erucamide. Catalyst deactivators may also commonly be used, for example, calcium stearate, hydrotalcite, and calcium oxide.

The ICP compositions of the present disclosure may advantageously show improvements over previous ICPs that do not include the propylene-based elastomer. Desirably, the ICP compositions described in the present disclosure may only partially break or may have no break at room temperature with Notched Izod Force of from 10 ft-lb/in² to 40 ft-lb/in² (or 10 ft-lb/in² to 20 ft-lb/in², or 20 ft-lb/in² to 30 ft-lb/in², or 20 ft-lb/in² to 40 ft-lb/in²) (21 kJ/m² to 84 KJ/m²) (Modified ASTM D256-10R18, 22° C.). See below for a description of test methods and description of “partial break” and “no break”.

The ICP compositions described in the present disclosure may have a 1% Secant Flexural Modulus (0.05 in/min, Modified ASTM D790-17) within a range of from 600 MPa to 1100 MPa (or 600 MPa to 850 MPa, or 600 MPa to 800 MPa, or 700 MPa to 900 MPa, or 750 MPa to 1000 MPa, or 800 MPa to 1100 MPa).

The ICP compositions described in the present disclosure may have a composition 1% Secant Flexural Modulus (0.05 in/min, Modified ASTM D790-17) such that the composition 1% Secant Flexural Modulus of the ICP composition is within 5% (or within 10%, or within 20%, or within 25%, or within 35%, or within 40%, or within 50%) of a comparative 1% Secant Flexural Modulus (0.05 in/min, Modified ASTM D790-17) of a comparative control sample. Furthermore, the ICP compositions described may have a composition Notched Izod Force (Modified ASTM D256-10R18, 22° C. greater than a comparative Notched Izod Force (Modified ASTM D256-10R18, 22° C.) of a comparative control sample. The ICP compositions described may have a composition Notched Izod Force (Modified ASTM D256-10R18, 22° C.) at least 5% greater (or at least 10% greater, or at least 20% greater, or at least 30% greater, or at least 40% greater, or at least 50% greater, or at least 75% greater, or at least 100% greater) than a comparative Notched Izod Force (Modified ASTM D256-10R18, 22° C.) of a comparative control sample.

Comparative control sample is defined for any embodiment of the present disclosure as a composition relative to the ICP composition of the embodiment. Comparative control sample refers to a composition comprising propylene and an ethylene-α-olefin copolymer in the same relative ratios as the ICP composition but not comprising the propylene based elastomer described in the present disclosure (e.g. the ICP composition can be viewed as comprising the comparative control sample and further comprising a propylene based elastomer). Each ICP composition within the present disclosure may have a comparative control sample associated therewith.

A property (e.g., flexural modulus, force, MFR, etc.) for a first composition being “within” a percentage (%) of a property for a second composition is defined relative to the second composition. So, for example, given that a first composition has a flexural modulus within 10% of a flexural modulus of a second composition, wherein the second composition has a flexural modulus of 100 MPa, the first composition would have a flexural modulus from 90 MPa to 110 MPa.

A property (e.g., flexural modulus, force, MFR, etc.) for a first composition being “at least” a percentage (%) “greater than” a property of a second composition is defined relative to the second composition. So, for example, given that a first composition has an MFR that is at least 5% greater than an MFR of a second composition, wherein the second composition has an MFR of 100 g/10 min, the first composition would have an MFR of 105 g/10 min or greater.

The compositions described may be used to form any number of articles, which typically includes melt blending the components described herein and forming them into articles either before or after allowing the melt to cool. The “cooled melt blend” is thus the reaction product of melt blending the components, taking into account the possibility that there could be some transformation of one or more of the components facilitated by the heating and/or mixing process.

Automotive components may be made from the presently described ICP compositions, such as dashboard components, interior side-door panels, instrument panels, air bag covers, or exterior components such as bumpers or bumper fascia, side panels, front bumpers and other components of the automobile. These components may be made by any desirable method including, but not limited to, melt extrusion or injection molding.

### Additional Embodiments

Embodiment 1. A thermoplastic polyolefin composition comprising: from 50 wt % to 90 wt %, by weight of the composition, of a polypropylene comprising from 90 wt % to 100 wt % propylene derived units and having a melt flow rate from 10 g/10 min to 200 g/10 min; from 10 wt % to 45 wt %, by weight of the composition, of an ethylene-α-olefin copolymer comprising from 30 wt % to 65 wt % ethylene-derived units and having a melt flow rate from 0.1 g/10 min to 10 g/10 min; from 0.1 wt % to 5 wt %, by weight of the composition, of a propylene-based elastomer having from 10 wt % to 60 wt % alpha-olefin derived units, having a melt flow rate from 0.1 g/10 min to 10 g/10 min; wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

Embodiment 2. The thermoplastic polyolefin composition of Embodiment 1, wherein the melt flow rate of the propylene-based elastomer is in a middle 50% range between the melt flow rate of the polypropylene and the melt flow rate of the ethylene-α-olefin copolymer.

Embodiment 3. The thermoplastic polyolefin composition of Embodiments 1 or 2, wherein the amount of the ethylene-derived units in the propylene-based elastomer is in a middle 50% range between the amount of ethylene-derived units in the polypropylene and the amount of the ethylene-derived units in the ethylene-α-olefin copolymer.

Embodiment 4. The thermoplastic polyolefin composition of any one of Embodiments 1-3, wherein the alpha-olefin of the propylene-based elastomer is selected from the group consisting of: butene, pentene, hexene, 4-methyl-1-pentene, octene, decene, and any combination thereof.

Embodiment 5. The thermoplastic polyolefin composition of any one of Embodiments 1-4, wherein an average particle size of a particle, comprising the propylene-based elastomer and the ethylene-polypropylene copolymer, is between 0.1 μm to 10 μm.

Embodiment 6. The thermoplastic polyolefin composition of any one of Embodiments 1-5, wherein the ethylene-α-olefin copolymer is dispersed as particles in a continuous phase comprising the polypropylene, and wherein an average interparticle spacing between the particles is between 0.1 μm to 0.5 μm.

Embodiment 7. The thermoplastic polyolefin composition of any one of Embodiments 1-6, wherein the ethylene-α-olefin copolymer has a high-load melt flow rate of from 100 g/10 min to 280 g/10 min.

Embodiment 8. The thermoplastic polyolefin composition of any one of Embodiments 1-7, wherein the composition has a composition 1% Secant Flexural Modulus within 5% of a comparative 1% Secant Flexural Modulus of a comparative control sample, and wherein a composition Notched Izod of the composition is greater than a comparative Notched Izod Force of the comparative control sample.

Embodiment 9. A melt extruded article comprising the thermoplastic polyolefin composition of any one of Embodiments 1-8.

Embodiment 10. An injection molded article comprising the thermoplastic polyolefin composition of any one of Embodiments 1-8.

Embodiment 11. An automotive component comprising the thermoplastic polyolefin composition of any one of Embodiments 1-8.

Embodiment 12. A method of injection molding an automotive component comprising melt extruding and injection molding the thermoplastic polyolefin composition of any one of Embodiments 1-8.

Embodiment 13. A method of producing a thermoplastic polyolefin composition comprising: (a) providing a polypropylene having a melt flow rate from 10 g/10 min to 200 g/10 min; (b) providing an ethylene-α-olefin copolymer comprising from 30 wt % to 65 wt % ethylene-derived units and having a melt flow rate from 0.1 g/10 min to 10 g/10 min; (c) providing a propylene-based elastomer having from 10 wt % to 60 wt % alpha-olefin derived units, having a melt flow rate from 0.1 g/10 min to 10 g/10 min; (d) forming a composition by combining, in any order, the polypropylene, the ethylene-polypropylene copolymer, and the propylene-based elastomer; (c) wherein the propylene comprises 50 wt % to 90 wt %, by weight of the composition; (f) wherein the ethylene-polypropylene copolymer comprises 10 wt % to 45 wt %, by weight of the composition; (g) wherein the propylene-based elastomer comprises 0.1 wt % to 5 wt %, by weight of the composition; and (h) wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

Embodiment 14. The method of Embodiment 13, wherein the propylene-based elastomer is added to a blend during a resin manufacturing pelletization step, wherein the blend comprises the polypropylene and the ethylene-α-olefin copolymer.

Embodiment 15. The method of Embodiments 13 or 14, wherein the propylene-based elastomer is added to a pellet during a post-manufacture pellet compounding process, wherein the pellet comprises the polypropylene and the ethylene-α-olefin copolymer.

Embodiment 16. The method of any one of Embodiments 13-15, wherein the propylene-based elastomer is produced in a series reactor, wherein the series reactor is configured to produce a blend which comprises the polypropylene and ethylene-α-olefin copolymer.

Embodiment 17. The method of any one of Embodiments 13-16, wherein the melt flow rate of the propylene-based elastomer is in a middle 50% range between the melt flow rate of the polypropylene and the melt flow rate of the ethylene-α-olefin copolymer.

Embodiment 18. The method of any one of Embodiments 13-17, wherein the amount of the ethylene-derived units in the propylene-based elastomer is in a middle 50% range between the amount of ethylene-derived units in the polypropylene and the amount of the ethylene-derived units in the ethylene-α-olefin copolymer.

Embodiment 19. The method of any one of Embodiments 13-18, wherein the alpha-olefin of the propylene-based elastomer is selected from the group consisting of: butene, pentene, hexene, 4-methyl-1-pentene, octene, decene, and any combination thereof.

Embodiment 20. The method of any one of Embodiments 13-19, wherein an average particle size of a particle, comprising the propylene-based elastomer and the ethylene-polypropylene copolymer, is between 0.1 μm to 10 μm.

To facilitate a better understanding of the embodiments of the present disclosure, the following examples of preferred or representative embodiments are given. In no way should the following examples be read to limit, or to define, the scope of the disclosure.

### EXAMPLES

### Test Methods

The ICP compositions were formulated in a 30-mm ZSK twin screw extruder. Compounding in the twin screw extruder was accomplished using an intense mixing screw element. The batch size was 5000 grams. The temperature profile in the various extruder zones was ramped progressively from 170° C. to 210° C. The compounds discharged from the extruder were pelletized.

Standard test specimens conforming to modified ASTM specifications were prepared through injection molding on a 300-ton Van Dorn press. The nozzle, front and rear temperatures of the injection molding equipment were maintained at 190° C. The mold temperature was kept constant at 27° C. The total cycle time was 54 seconds and the injection pressure was 4 MPa. A family mold containing various ASTM specimen cavities was used. The ExxonMobil Test method is described in T. C. Yu “Impact Modification of Polypropylenes with Exact Plastomers”, SOC. OF PLASTICS ENGINEERS, ANTEC (May 1994).

For this test method, high-speed puncture testing based on ASTM D256-10R18 was used to study impact behavior. This test continuously measures the applied force and time during the impact event. The electronically collected data points are next processed through a computer to provide graphic representation of both force and energy as a function of displacement.

A drop-weight tester, Ceast Fractovis, was used to gather the data. It consists of three main parts: clamp assembly, plunger assembly, and IBM PC based control unit. Two parallel rigid plates with a large opening to expose the test specimen form the clamp assembly. Both the top and bottom plates are of the same dimension. The plunger assembly consists of a steel rod with a removable hemispherical tip to hold the measuring strain gauge. It is located perpendicular to and centered on the clamp hole. A control unit regulates the plunger test speed, as well as records the load and displacement data. Similar to the conventional Notched Izod testing, the test geometries need to be carefully defined because they are not precisely specified in the ASTM procedure. A 20 mm diameter hemispherical striker and a 40 mm opening clamp were used for this study. The test speed was set at 4 msec. A force-displacement graph may be generated for a ductile material. Integration of the force displacement curve, in turn, yields an energy-displacement curve. Initially, a ductile material may behave as clastic solid in that deformation is proportional to the displacement. The initial slope of the generated graph is therefore a measure of the sample stiffness. After the elastic region, the sample starts to yield to the advancing plunger. At the yield point, the sample exerts its maximum resistance, the yield point is therefore the highest point on the force-displacement curve.

Afterwards, the high speed plunger initiates a crack in the sample and starts its downward penetration of the test specimen. The sample then starts to draw to accommodate the advancing plunger. Finally the plunger punctures through the test specimen; and, lastly, a small amount of energy is needed to overcome the friction between the test plunger and the plastic sample. Because of the large extent of this sample drawing, the total energy is approximately twice the yield energy. A ductility index (DI) can be defined as: DI=[(Total Energy−Yield Energy)/Yield Energy)×100]. The codes in the tables for the failure modes are as follows: C=complete break, H=hinged crack/break (an incomplete break such that one part of the specimen cannot support itself above the horizontal when the other part is held vertically), P=partial break (a break that does not meet the definition of a hinged break, but has a fracture of at least 90% of the distance between the vertex of the notch and the opposite side of the specimen), NB=no break. Other test methods are listed in the Table 1 below.

TABLE 1

| Tests | Method |
|---|---|
| RTNI (Room | Modified ASTM D256-10R18, 22° C. (BOY |
| Temperature Notched | injection molder, injection pressure 900-1000 |
| Izod) Impact (J/m²) ft- | psi and velocity 50%, holding pressure 900-950 |
| lb/in² | psi and velocity of 10%, plasticizing pressure |
| | 150 psi and velocity 15%, holding time 3 sec, 2- |
| | 4 days of room temperature conditioning) |
| 1% Secant Flexural | Modified ASTM D790-17 (speed 1 mm/min, |
| Modulus (MPa) psi | span 30 mm) |
| Melt Flow Rate (g/10 | ASTM D1238-20, Condition L: 230° C. and 2.16 |
| min) | kg |
| Glass Transition | DSC, ASTM E1356-08R14, at a heating rate of |
| Temperature (T_{g}) | 5° C./minute |

### Preparation of Propylene-Based Elastomer

Propylene-based clastomer (PBE) samples were prepared having the properties including C2 wt % and melt flow rate (MFR) provided in Table 2.

TABLE 2

| Sample | C2 wt % | MFR (g/10 min) |
|---|---|---|
| PBE 1 | 11 | 7 |
| PBE 2 | 13.2 | 5.7 |
| PBE 3 | 13.8 | 4 |
| PBE 4 | 14.9 | 5.8 |
| PBE 5 | 16.6 | 2.4 |
| PBE 6 | 18 | 5.8 |
| PBE 7 | 20.3 | 2.2 |
| PBE 8 | 20.4 | 4.6 |
| PBE 9 | 22.4 | 2 |
| PBE 10 | 26.2 | 1.4 |

### Example 1

ICP samples were prepared by compounding various propylene-based elastomers with PP8255E1-30 (an impact copolymer (ICP) comprising a polypropylene and an ethylene-propylene copolymer having an MFR of 30 g/10 min, available from ExxonMobil).

The control sample (Control 1-1) is the PP8255E1-30 alone. The comparative example (CE 1-1) is the PP8255E1-30 blended with 3 wt % of the ethylene-propylene copolymer (about 56 wt % ethylene content) present in the PP8255E1-30. The inventive examples (IE 1-1 thru IE 1-10) are the PP8255E1-30 blended with 3 wt % of the propylene-based elastomers (PBE 1 thru PBE 10, respectively) of Table 2.

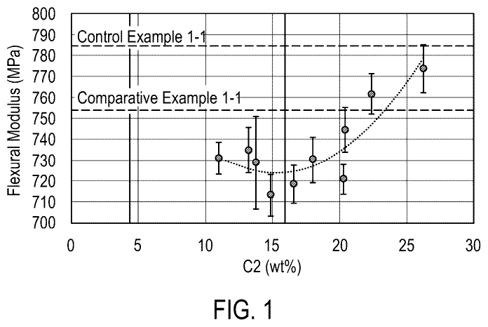

ICP samples were tested according to a variety of methods with data reported in Table 3 below. 1% Secant Flexural Modulus testing (conducted according to test conditions described above) is visible in FIG. 1. Said testing demonstrated that samples including the propylene-based elastomer yielded lower flexural modulus values than control compositions with no propylene-based elastomer added. Additionally, testing demonstrated an increase in Flexural Modulus values with higher C2 wt % in the propylene-based elastomer samples prepared.

TABLE 3

| | | Compatibilizer | Flexural | RTNI | |
|---|---|---|---|---|---|
| | Compatibilizer | MFR (g/10 | Modulus | (ft- | Break |
| Sample | C2 wt % | min) | (MPa) | lb/in) | Type |
| Control 1-1 | — | — | 785 | 3.13 | C |
| CE 1-1 | 56 | — | 754 | | NB |
| IE 1-1 | 11 | 7 | 731 | | NB |
| IE 1-2 | 13.2 | 5.7 | 735 | | NB |
| IE 1-3 | 13.8 | 4 | 729 | | NB |
| IE 1-4 | 14.9 | 5.8 | 713 | | NB |
| IE 1-5 | 16.6 | 2.4 | 718 | | NB |
| IE 1-6 | 18 | 5.8 | 730 | | NB |
| IE 1-7 | 20.3 | 2.2 | 721 | | NB |
| IE 1-8 | 20.4 | 4.6 | 745 | | NB |
| IE 1-9 | 22.4 | 2 | 762 | | NB |
| IE 1-10 | 26.2 | 1.4 | 774 | | NB |

“C” indicates complete break occurred;
“NB” indicates no break occurred

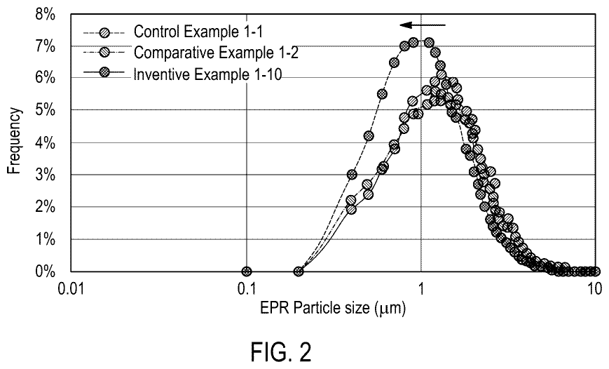

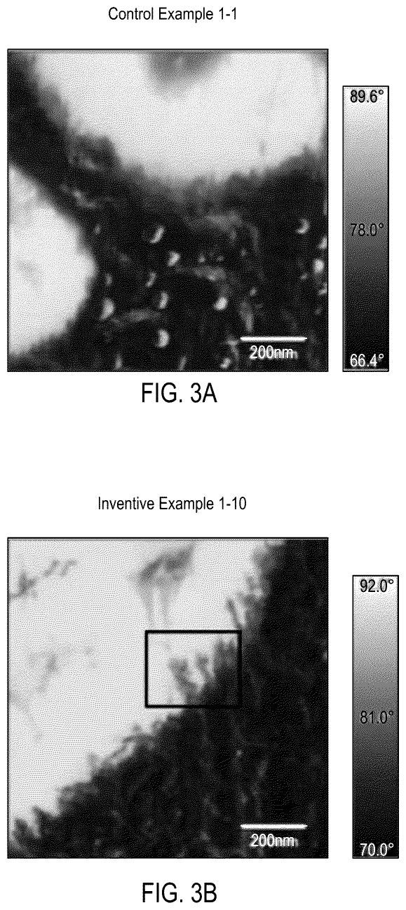

Additionally, samples were cryo-faced using a cryo-microtom (Leica) and examined afterward by a tapping phase AFM (atomic force microscopy, Icon, Bruker). AFM showed a difference in the size of ethylene-propylene copolymer phases particles of control samples as compared with samples which included the propylene-based elastomer. This shift can be viewed in FIG. 2. Additionally, interfacial differences were observed as visible in FIG. 3A and FIG. 3B.

### Example 2

The Flexural Modulus and RTNI testing of Example 1 was repeated with ICP samples prepared by compounding various propylene-based elastomers with granules of PP8255E1-30. Results are reported in Table 4 below.

The control sample (Control 2-1) is the granules of PP8255E1-30 alone. The comparative example (CE 2-1) is granules of PP8255E1-30 blended with 3 wt % of the ethylene-propylene copolymer present in the granules of PP8255E1-30. The inventive examples IE 2-5 and IE 2-9 are the granules of PP8255E1-30 blended 3 wt % of PBE 5 and PBE 9, respectively, of Table 2.

TABLE 4

| | | Compatibilizer | Flexural | RTNI | |
|---|---|---|---|---|---|
| | Compatibilizer | MFR (g/10 | Modulus | (ft- | Break |
| Sample | C2 wt % | min) | (MPa) | lb/in) | Type |
| Control 2-1 | — | — | 836 | 3.095 | C |
| CE 2-1 | 56 | — | 760 | | NB |
| IE 2-5 | 16.6 | 2.4 | 746 | | NB |
| IE 2-9 | 22.4 | 2 | 774 | | NB |

“C” indicates complete break occurred;
“NB” indicates no break occurred

### Example 3

The Flexural Modulus and RTNI testing of Example 1 was repeated with ICP samples prepared by compounding various propylene-based elastomers with pellets of PP8255E1-30. Results are reported in Table 5 below.

The control sample (Control 3-1) is the pellets of PP8255E1-30 alone. The comparative example (CE 3-1) is pellets of PP8255E1-30 blended with 3 wt % of the ethylene-propylene copolymer present in the pellets of PP8255E1-30. The inventive examples IE 3-5 and IE 3-9 are the pellets of PP8255E1-30 blended with 3 wt % of PBE 5 and PBE 9, respectively, of Table 2.

TABLE 5

| | | Compatibilizer | Flexural | RTNI | |
|---|---|---|---|---|---|
| | Compatibilizer | MFR (g/10 | Modulus | (ft- | Break |
| Sample | C2 wt % | min) | (MPa) | lb/in) | Type |
| Control 3-1 | — | — | 955 | 2.293 | C |
| CE 3-1 | 56 | — | 923 | 2.843 | C |
| IE 3-5 | 16.6 | 2.4 | 874 | | NB |
| IE 3-9 | 22.4 | 2 | 950 | 3.205 | C |

“C” indicates complete break occurred;
“NB” indicates no break occurred

### Example 4

The Flexural Modulus and RTNI testing of Example 1 was repeated with ICP samples prepared by compounding various propylene-based elastomers with pellets of PP8255E1-50 (an impact copolymer (ICP) comprising a polypropylene and an ethylene-propylene copolymer having an MFR of 50 g/10 min, available from ExxonMobil). Results are reported in Table 6 below.

The control sample (Control 4-1) is the pellets of PP8255E1-50 alone. The comparative example (CE 4-1) is pellets of PP8255E1-50 blended with 3 wt % of the ethylene-propylene copolymer present in the pellets of PP8255E1-50. The inventive examples IE 4A-5 and IE 4B-5 are the pellets of PP8255E1-50 blended with PBE 5 (of Table 2) at 3 wt % and 6 wt %, respectively. The inventive examples IE 4A-10 and IE 4B-10 are the pellets of PP8255E1-50 blended with PBE 10 (of Table 2) at 3 wt % and 6 wt %, respectively.

TABLE 6

| | | Compatibilizer | | Flexural | | |
|---|---|---|---|---|---|---|
| | Compatibilizer | MFR (g/10 | PBE | Modulus | RTNI (ft- | Break |
| Sample | C2 wt % | min) | wt % | (MPa) | lb/in) | Type |
| Control 4-1 | — | — | — | 891 | 1.886 | C |
| CE 4-1 | 56 | — | — | 872 | 2.119 | C |
| IE 4A-5 | 16.6 | 2.4 | 3 | 851 | | NB |
| IE 4B-5 | 16.6 | 2.4 | 6 | 746 | | NB |
| IE 4A-10 | 26.2 | 1.4 | 3 | 843 | 2.658 | C |
| IE 4B-10 | 26.2 | 1.4 | 6 | 814 | 4.704 | C |

“C” indicates complete break occurred;
“NB” indicates no break occurred

### Example 5

The Flexural Modulus and RTNI testing of Example 1 was repeated with ICP samples prepared by compounding various propylene-based elastomers with pellets of PP8255E1-70 (an impact copolymer (ICP) comprising a polypropylene and an ethylene-propylene copolymer having an MFR of 70 g/10 min, available from ExxonMobil). Results are reported in Table 7 below.

The control sample (Control 5-1) is the pellets of PP8255E1-70 alone. The comparative example (CE 5-1) is pellets of PP8255E1-70 blended with 3 wt % of the ethylene-propylene copolymer present in the pellets of PP8255E1-70. The inventive examples IE 5A-5 and IE 5B-5 are the pellets of PP8255E1-70 blended with PBE 5 (of Table 2) at 3 wt % and 6 wt %, respectively. The inventive examples IE 5A-10 and IE 5B-10 are the pellets of PP8255E1-70 blended with PBE 10 (of Table 2) at 3 wt % and 6 wt %, respectively.

TABLE 7

| | | Compatibilizer | | Flexural | | |
|---|---|---|---|---|---|---|
| | Compatibilizer | MFR (g/10 | PBE | Modulus | RTNI (ft- | Break |
| Sample | C2 wt % | min) | wt % | (MPa) | lb/in) | Type |
| Control 5-1 | — | — | — | 837 | 1.619 | C |
| CE 5-1 | 56 | — | — | 824 | 1.555 | C |
| IE 5A-5 | 16.6 | 2.4 | 3 | 771 | | NB |
| IE 5B-5 | 16.6 | 2.4 | 6 | 660 | | NB |
| IE 5A-10 | 26.2 | 1.4 | 3 | 772 | 2.276 | C |
| IE 5B-10 | 26.2 | 1.4 | 6 | 771 | 2.602 | C |

“C” indicates complete break occurred;
“NB” indicates no break occurred

One or more illustrative embodiments incorporating the disclosure embodiments disclosed herein are presented herein. Not all features of a physical implementation are described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present disclosures. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is the following:

1. A thermoplastic polyolefin composition comprising:
from 50 wt % to 90 wt %, by weight of the composition, of a polypropylene comprising from 90 wt % to 100 wt % propylene derived units and having a melt flow rate from 10 g/10 min to 200 g/10 min;
from 10 wt % to 45 wt %, by weight of the composition, of an ethylene-α-olefin copolymer comprising from 30 wt % to 65 wt % ethylene-derived units and having a melt flow rate from 0.1 g/10 min to 10 g/10 min;
from 0.1 wt % to 5 wt %, by weight of the composition, of a propylene-based elastomer having from 10 wt % to 60 wt % alpha-olefin derived units, having a melt flow rate from 0.1 g/10 min to 10 g/10 min;
wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

2. The thermoplastic polyolefin composition of claim 1, wherein the melt flow rate of the propylene-based elastomer is in a middle 50% range between the melt flow rate of the polypropylene and the melt flow rate of the ethylene-α-olefin copolymer.

3. The thermoplastic polyolefin composition of claim 1, wherein the amount of the ethylene-derived units in the propylene-based elastomer is in a middle 50% range between the amount of ethylene-derived units in the polypropylene and the amount of the ethylene-derived units in the ethylene-α-olefin copolymer.

4. The thermoplastic polyolefin composition of claim 1, wherein the alpha-olefin of the propylene-based elastomer is selected from the group consisting of: butene, pentene, hexene, 4-methyl-1-pentene, octene, decene, and any combination thereof.

5. The thermoplastic polyolefin composition of claim 1, wherein an average particle size of a particle, comprising the propylene-based elastomer and the ethylene-polypropylene copolymer, is between 0.1 μm to 10 μm.

6. The thermoplastic polyolefin composition of claim 1, wherein the ethylene-α-olefin copolymer is dispersed as particles in a continuous phase comprising the polypropylene, and wherein an average interparticle spacing between the particles is between 0.1 μm to 0.5 μm.

7. The thermoplastic polyolefin composition of claim 1, wherein the ethylene-α-olefin copolymer has a high-load melt flow rate of from 100 g/10 min to 280 g/10 min.

8. The thermoplastic polyolefin composition of claim 1, wherein the composition has a composition 1% Secant Flexural Modulus within 5% of a comparative 1% Secant Flexural Modulus of a comparative control sample, and wherein a composition Notched Izod of the composition is greater than a comparative Notched Izod Force of the comparative control sample.

9. A melt extruded article comprising the thermoplastic polyolefin composition of claim 1.

10. An injection molded article comprising the thermoplastic polyolefin composition of claim 1.

11. An automotive component comprising the thermoplastic polyolefin composition of claim 1.

12. A method of injection molding an automotive component comprising melt extruding and injection molding the thermoplastic polyolefin composition of claim 1.

13. A method of producing a thermoplastic polyolefin composition comprising:
(a) providing a polypropylene having a melt flow rate from 10 g/10 min to 200 g/10 min;
(b) providing an ethylene-α-olefin copolymer comprising from 30 wt % to 65 wt % ethylene-derived units and having a melt flow rate from 0.1 g/10 min to 10 g/10 min;
(c) providing a propylene-based elastomer having from 10 wt % to 60 wt % alpha-olefin derived units, having a melt flow rate from 0.1 g/10 min to 10 g/10 min;
(d) forming a composition by combining, in any order, the polypropylene, the ethylene-polypropylene copolymer, and the propylene-based elastomer;
(e) wherein the propylene comprises 50 wt % to 90 wt %, by weight of the composition;
(f) wherein the ethylene-polypropylene copolymer comprises 10 wt % to 45 wt %, by weight of the composition;
(g) wherein the propylene-based elastomer comprises 0.1 wt % to 5 wt %, by weight of the composition; and
(h) wherein the melt flow rate of the propylene-based elastomer is between the melt flow rate of the polypropylene and the melt flow rate of the ethylene-α-olefin copolymer, and wherein an amount of the ethylene-derived units in the propylene-based elastomer is between an amount of ethylene-derived units in the polypropylene and an amount of the ethylene-derived units in the ethylene-α-olefin copolymer.

14. The method of claim 13, wherein the propylene-based elastomer is added to a blend during a resin manufacturing pelletization step, wherein the blend comprises the polypropylene and the ethylene-α-olefin copolymer.

15. The method of claim 13, wherein the propylene-based elastomer is added to a pellet during a post-manufacture pellet compounding process, wherein the pellet comprises the polypropylene and the ethylene-α-olefin copolymer.

16. The method of claim 13, wherein the propylene-based elastomer is produced in a series reactor, wherein the series reactor is configured to produce a blend which comprises the polypropylene and ethylene-α-olefin copolymer.

17. The method of claim 13, wherein the melt flow rate of the propylene-based elastomer is in a middle 50% range between the melt flow rate of the polypropylene and the melt flow rate of the ethylene-α-olefin copolymer.

18. The method of claim 13, wherein the amount of the ethylene-derived units in the propylene-based elastomer is in a middle 50% range between the amount of ethylene-derived units in the polypropylene and the amount of the ethylene-derived units in the ethylene-α-olefin copolymer.

19. The method of claim 13, wherein the alpha-olefin of the propylene-based elastomer is selected from the group consisting of: butene, pentene, hexene, 4-methyl-1-pentene, octene, decene, and any combination thereof.

20. The method of claim 13, wherein an average particle size of a particle, comprising the propylene-based elastomer and the ethylene-polypropylene copolymer, is between 0.1 μm to 10 μm.
